(19) United States
(12) Patent Application Publication
(10) Pub. No.: US 2010/0135898 A1
(43) Pub. Date: Jun. 3, 2010

(54) METHOD FOR PRODUCING METAL HYDRIDE

(75) Inventors: Yoshitsugu Kojima, Hiroshima (JP); Hironobu Fujii, Hiroshima (JP); Takayuki Ichikawa, Hiroshima (JP); Satoshi Hino, Hiroshima (JP); Haiyan Leng, Hiroshima (JP); Kyoichi Tange, Hiroshima (JP); Chie Omatsu, Hiroshima (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: TAIHEIYO CEMENT CORPORATION, TOKYO (JP); HIROSHIMA UNIVERSITY, HIROSHIMA (JP)

(21) Appl. No.: 12/531,131

(22) PCT Filed: Mar. 14, 2008
(86) PCT No.: PCT/JP08/00590

§ 371 Date: Jan. 6, 2010

(30) Foreign Application Priority Data
Mar. 14, 2007 (JP) 2007-065315
Sep. 14, 2007 (JP) 2007-239376

(51) Int. Cl. C01B 6/04; C01B 6/00

(52) U.S. Cl. 423/646; 423/645

(57) ABSTRACT

Disclosed is a method for producing a metal hydride, which enables to obtain a metal hydride from a metal imide or a metal amide. Specifically, in an air current containing a hydrogen gas having a hydrogen partial pressure of 0.1 MPa or greater, hydrogen is reacted with one or both of a metal imide and a metal amide, thereby producing a metal hydride. The metal constituting the metal amide and the metal imide is preferably lithium, sodium or potassium.

### TECHNICAL FIELD

The present invention relates to a method for producing a metal hydride, and in particular to a method for producing a metal hydride from a metal amide and a metal imide.

### BACKGROUND ART

Hydrogen is an important chemical raw material being used in large quantity in various industrial fields such as synthetic chemistry and petroleum refinery. A fuel cell that produces electric power by using hydrogen as a fuel has actively been developed as a clean energy source that does not produce harmful substances, such as NOₓ and SOₓ, or greenhouse gases, such as CO₂, resulting in global warming.

As methods for storing hydrogen, a method of compressing hydrogen for storage in a high-pressure cylinder, a method of cooling and liquefying hydrogen for storage, a method of storing hydrogen in a hydrogen storage substance, such as an activated carbon or a hydrogen storage alloy, and the like are known.

Among such methods for storing hydrogen, the method of storing hydrogen in a hydrogen storage substance has been particularly drawing attention as a hydrogen storage method to supply hydrogen used for operation of a fuel cell installed on a mobile object such as a fuel-cell vehicle. However, for example, a hydrogen storage alloy as a kind of hydrogen storage substance is disadvantageous in that a small hydrogen storage rate per unit mass thereof is small, which is 1 to 2 mass %, due to high specific gravity.

Therefore, recently, a method for producing hydrogen by reacting a metal hydride with ammonia (NH₃) has attracted attention (see, for example, Japanese Patent Application Laid-Open No. 2005-154232, paragraph [0010] and others). For example, when a lithium hydride (LiH) is in contact with NH₃, hydrogen is produced according to a reaction equation of “LiH+NH₃→LiNH₂+H₂”.

Use of this reaction is advantageous in that “LiH+NH₃” which are raw materials are lightweight and hydrogen production rate per unit mass of the raw materials is high, which is approximately 8 mass % (=mass of H₂/mass of (LiH+NH₃)). When the generated LiNH₂ is in contact with an unreacted LiH, hydrogen is produced according to a reaction equation of “LiNH₂+LiH→H₂” and a lithium imide (Li₂NH) is concurrently obtained as a by-product.

However, in the method for generating hydrogen, although it is preferable to return LiNH₂ and Li₂NH produced concurrently with hydrogen production to LiH again for reuse, any practical producing method for obtaining LiH from LiNH₂ or Li₂NH has not been reported.

### DISCLOSURE OF THE INVENTION

### Problem to be Solved by the Invention

In view of the foregoing circumstances, it is an object of the present invention to provide a method for producing a metal hydride from a metal amide and a metal imide at a high inversion rate.

### Means for Solving the Problem

According to the present invention, there is provided a method for producing a metal hydride by reacting hydrogen with one or both of a metal amide and a metal imide in a gas flow containing the hydrogen having a hydrogen partial pressure of 0.1 MPa or greater.

This method for producing a metal hydride is preferably used, particularly when the metal constituting the metal amide and the metal imide is lithium, sodium or potassium.

### Effect of the Invention

According to the present invention, a metal hydride can be produced from a metal amide and a metal imide at a high conversion rate. Hence, the present invention is adaptable to, for example, use as a hydrogen supply source which requires a hydrogen release/storage cycle of a fuel cell or the like.

### BRIEF DESCRIPTION OF THE DRAWINGS

FIG. 1 shows XRD charts of products obtained by heat-treating LiNH₂ in an H₂ flow;

FIG. 2 shows XRD charts of products obtained by heat-treating Li₂NH in a H₂ flow;

FIG. 3 is an XRD chart of a product obtained by heat-treating LiNH₂ in a sealed atmosphere;

FIG. 4 is a graph showing hydrogen release amount of a standard sample for LiH purity evaluation;

FIG. 5 shows XRD charts of products obtained by heat-treating NaH in an NH₃ gas atmosphere;

FIG. 6 shows XRD charts of products obtained by heat-treating NaNH₂ in a H₂ flow;

FIG. 7 shows XRD charts of products obtained by heat-treating KNH₂ in an H₂ flow, where
(a) shows a product obtained by heat-treating K in a hydrogen atmosphere,
(b) shows a product obtained by reacting KH in an NH₃ atmosphere at a room temperature, and
(c) shows a product obtained by heat-treating KNH₂ in an H₂ flow;

FIG. 8 shows results of measurement with a differential scanning calorimeter (DSC) in an H₂ flow, where
(a) shows Example 7 (KNH₂ powder),
(b) shows Example 8 (NaNH₂ powder), and
(c) shows Example 9 (LiNH₂ powder)

### BEST MODE FOR CARRYING OUT THE INVENTION

In a method for producing a metal hydride according to the present invention, a metal hydride is produced by reacting hydrogen (H₂) with one or both of a metal amide and a metal imide in an gas flow containing a hydrogen (H₂) gas having a hydrogen partial pressure (H₂ partial pressure) of 0.1 MPa or greater.

The gas flow containing a H₂ gas having a H₂ partial pressure of 0.1 MPa or greater means that, in the case of pure H₂ gas, the pressure of H₂ gas is 0.1 MPa or greater and that, in the case of a mixed gas including other gases, the partial pressure of H₂ gas contained therein is 0.1 MPa or greater.

When a mixed gas is used, other gases need to have properties which do not inhibit a production reaction of a metal hydride. Specifically, an inert gas such as helium (He) gas, argon (Ar) gas or nitrogen (N₂) gas is used.

Examples of the metal amide include lithium amide (LiNH₂), sodium amide (NaNH₂), potassium amide (KNH₂), magnesium amide (Mg(NH₂)₂) and calcium amide (Ca(NH₂)₂).

For example, a chemical reaction equation for obtaining lithium hydride (LiH) which is the metal hydride from LiNH₂ is as follows:

LiNH₂+H₂→LiH+NH₃ (1A).

This equation (1A) indicates that ammonia (NH₃) is produced concurrently with production of LiH. To advance the reaction from the viewpoint of the production of LiH, the generated NH₃ is preferably released to the outside of the reaction system. Accordingly, in circulating a gas containing H₂ gas supplied to the reaction for use, it is necessary to provide means for removing NH₃ in a circulating path.

The chemical reaction of the equation (1A) is a reversible reaction and a reaction expressed by the following equation can be produced under a predetermined condition:

LiH+NH₃→LiNH₂+H₂ (1B).

For example, in the case of the reaction of the equation (1A), LiH can be synthesized at a reaction rate of approximately 100% by performing the reaction at a H₂ partial pressure of 0.5 MPa and a reaction temperature of 300° C. for a predetermined period (e.g., 4 hours). On the other hand, in the case of the reaction of the equation (1B), LiNH₂ can be synthesized at a reaction rate of approximately 100% by performing the reaction at a NH₃ gas partial pressure of 0.9 MPa and a room temperature for 24 hours. Reaction systems of the equations (1A), (1B) represent a kind of hydrogen storage material capable of repeatedly performing hydrogen release/storage.

A chemical reaction equation for obtaining sodium hydride (NaH) which is a metal hydride from NaNH₂ is expressed as follows:

NaNH₂+H₂→NaH+NH₃ (2A).

This reaction is an endothermic reaction. NaH can be synthesized at a reaction rate of approximately 100% by performing the reaction at a H₂ partial pressure of 0.5 MPa and a reaction temperature of 200° C. for a predetermined period (e.g., 4 hours).

The chemical reaction of the equation (2A) is also a reversible reaction and an exothermic reaction expressed by the following equation proceeds at a room temperature:

NaH+NH₃→NaNH₂+H₂ (2B).

For example, by maintaining a NH₃ gas partial pressure at 0.5 MPa at a room temperature for 24 hours, NaNH₂ can be obtained at a reaction rate of approximately 62%. When the reaction of the equation (1B) is performed under the same conditions, LiNH₂ can be obtained at a reaction rate of approximately 50%. Comparison of these reactions and comparison of conditions and results of the reactions of the equations (1A) and (2A) indicate that in a reversible reaction system between “metal amide+hydrogen” and “metal hydride+ammonia”, a higher reactivity is obtained when Na is used as the metal species than Li. This is considered to be because NaNH₂ and NaH are more unstable than LiNH₂ and LiH, respectively.

Through reactions of the equations (1B), (2B), a reaction rate of approximately 100% can be obtained by performing milling operations at a HN₂ gas partial pressure of 0.5 MPa for two hours. Reaction systems of the equations (2A), (2B) also represent a kind of hydrogen storage material capable of repeatedly performing hydrogen release/hydrogen storage.

A chemical reaction equation for obtaining potassium hydride (KH) which is a metal hydride from KNH₂ is as follows:

KNH₂+H₂→KH+NH₃ (3A).

This reaction is an endothermic reaction. For example, by raising a temperature to 300° C. at a temperature rising rate of 5° C./min under a H₂ partial pressure of 0.5 MPa, KH can be synthesized at a reaction rate of approximately 90%.

The chemical reaction of the equation (3A) is also a reversible reaction and an exothermic reaction expressed by the following equation proceeds at a room temperature:

KH+NH₃→KNH₂+H₂ (3B).

For example, by maintaining a NH₃ gas partial pressure at 0.5 MPa at a room temperature for 24 hours, KNH₂ can be obtained. Reaction systems of the equations (3A), (3B) may also be regarded as a kind of hydrogen storage material capable of repeatedly performing hydrogen release/storage.

Examples of the metal imide include lithium imide (Li₂NH), sodium imide (Na₂NH), potassium imide (K₂NH), magnesium imide (MgNH) or calcium imide (CaNH). For example, a chemical reaction equation for obtaining LiH from Li₂NH is as follows:

Li₂NH+2H₂→2LiH+NH₃ (4).

LiH is produced by reacting Li₂NH with H₂ at a molar ratio of 1:2. Given the equations (1A) and (4), it is appreciated that a raw material for producing LiH may be a mixture of LiNH₂ and Li₂NH.

In the case of the equation (4) as well, it is indicated that NH₃ is produced concurrently with production of LiH. Accordingly, from the viewpoint of LiH production, the produced NH₃ need to be released to the outside of the reaction system in the same way as in the case where LiNH₂ is used as a starting material as described above. The reaction of the equation (4) is also a reversible reaction, which represents a kind of hydrogen storage material capable of repeatedly performing hydrogen release/storage.

A preferable reaction temperature for obtaining the various types of metal hydrides described above depends upon a metal species. Too low reaction temperature causes a problem of decreasing the purity of metal hydride in a reaction product. On the other hand, too high reaction temperature may make it impossible to obtain a metal hydride due a decomposition reaction of a raw material itself. For example, in a case where LiNH₂ is a raw material, the reaction temperature is set to a temperature at which a reaction of “2LiNH₂→Li₂NH+NH₃”, which is the decomposition reaction, will not occur.

The reason why an H₂ partial pressure of a reaction atmosphere is set to 0.1 MPa or greater is that LiH purity in a reaction product is decreased when the partial pressure is less than 0.1 MPa as shown in an example described below. An upper limit of the H₂ partial pressure in the reaction atmosphere is determined from the viewpoint of safety required for a reaction apparatus rather than a viewpoint emphasizing on the reaction efficiency of a metal hydride in the obtained product.

This method for producing metal hydride is suitably used, particularly when metal constituting a metal amide and a metal imide is lithium, sodium or potassium.

Now, the present invention will described below in more detail, by way of examples.

### Examples

### [Li System]

[Sample Preparation and Structural Analysis with X-Ray Diffraction Apparatus]

### Examples 1 and 2, Comparative Example 1

LiNH₂ (produced by Sigma Aldrich Co., Ltd., Purity: 95% (the same was used for LiNH₂ hereinafter described)) was weighed to 300 mg, which was then put into a mill container (internal capacity: 250 ml) mounted on a planetary ball mill apparatus (manufactured by Fritsch Co., Ltd., model: P-5) and, after the inside of the mill container was evacuated, Ar gas (purity: 99.995%) was introduced such that an inner pressure was 0.9 MPa for performing milling treatment for 2 hours.

5 mg of the obtained crushed particles was taken and retained in a gas flow having a H₂ partial pressure of 0.05 MPa at 300° C. for 4 hours. “A H₂ partial pressure of 0.05 MPa” is achieved by “a mixture of H₂ gas and Ar gas having a total pressure of 0.25 MPa” (which is the same for the examples below).

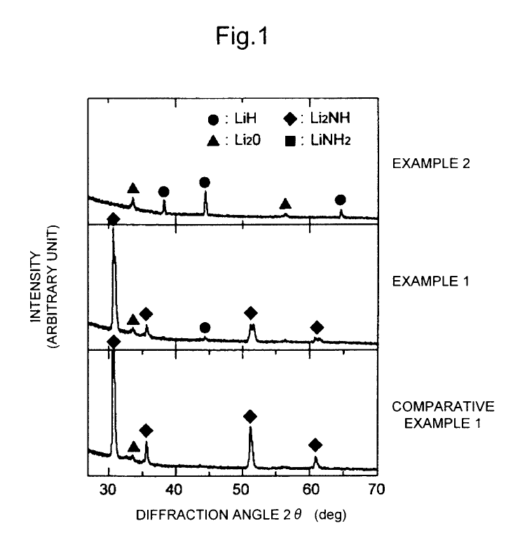

Subsequently, the resulting heat-treated product (=Comparative Example 1) was taken and phase-identified by the powder X-ray diffraction method (XRD). Similarly, a heat-treated product (=Example 1) was prepared under heat-treatment atmosphere having an H₂ flow (H₂ gas: 0.1 MPa, Ar gas: 0.15 MPa) of a H₂ partial pressure of 0.1 MPa, and a heat-treated product (=Example 2) was prepared under heat-treatment atmosphere having a pure H₂ gas flow of 0.5 MPa, and phase-identified by the XRD. FIG. 1 shows the XRD charts.

As shown in FIG. 1, in the Comparative Example 1 where the H₂ partial pressure is low during heat treatment, production of LiH was not observed, while production of LiH was observed in Examples 1 and 2. Comparison of peak strength of LiH to that of LiNH₂ indicates that a sample having a higher H₂ partial pressure contains a larger amount of LiH. In other words, to accelerate a production reaction of LiH, it is found that a H₂ gas pressure is preferably increased.

### Examples 3 and 4 and Comparative Example 2

Sample preparation and evaluation methods for Examples 3 and 4 and Comparative Example 2 were in accordance with those of Examples 1 and 2 and Comparative Example 1, except that Li₂NH was used in place of LiNH₂ as a starting material. Li₂NH was prepared by heating LiNH₂ at 450° C. in vacuum.

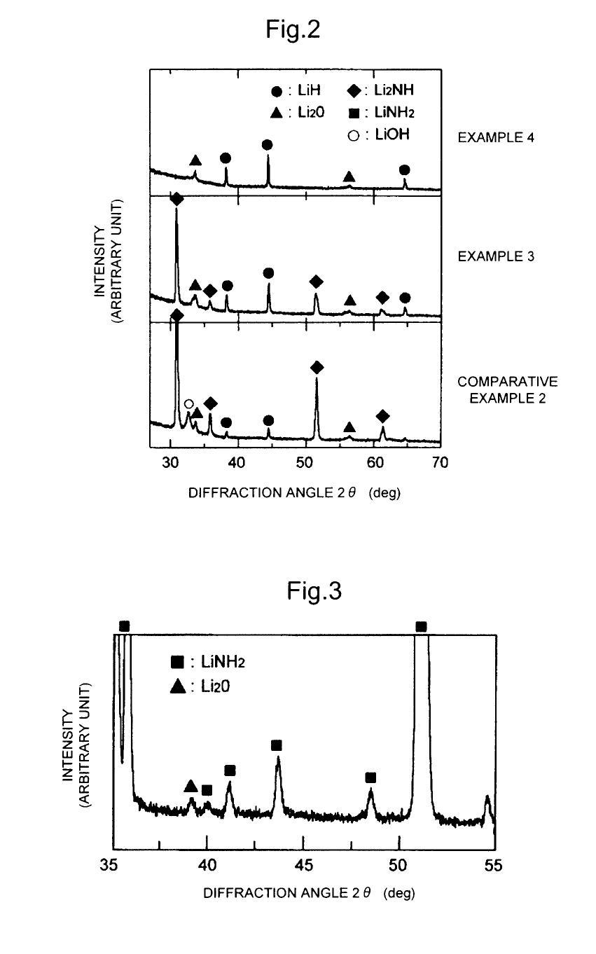

FIG. 2 shows XRD charts of the obtained samples. As shown in FIG. 2, a sample (=Comparative Example 2) obtained at a H₂ partial pressure of 0.05 MPa had a peak indicating the presence of LiH, but the strength was very low as compared to that of a peak of Li₂NH of a raw material. On the other hand, a sample (=Example 3) obtained at a H₂ partial pressure of 0.1 MPa and a sample (=Example 4) obtained at a H₂ partial pressure of 0.5 MPa have a large LiH peak and remarkable decrease in the peak strength of Li₂NH. It was verified that increasing an H₂ partial pressure accelerates a production reaction of LiH.

### Comparative Example 3

LiNH₂ was weighed to 300 mg, which was then subjected to milling treatment using the planetary ball mill apparatus, model P-5, for two hours. Next, 100 mg of the obtained crushed particles was taken and retained at 300° C. for 200 hours in a sealed atmosphere of pure H₂ gas of 1 MPa. Subsequently, the resulting heat-treated product (=Comparative Example 3) was phase-identified by the powder X-ray diffraction method (XRD).

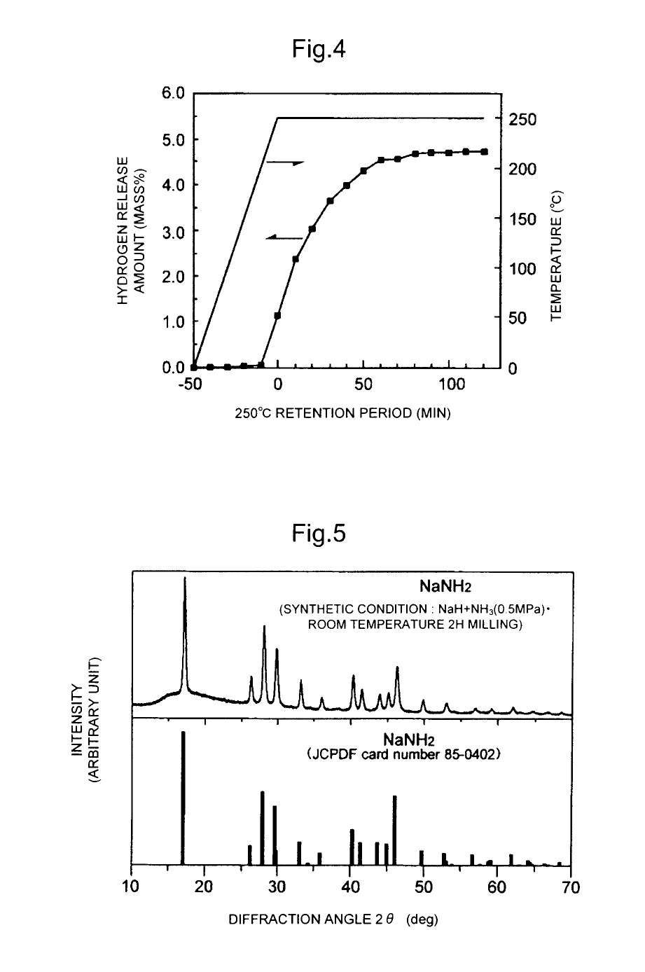

FIG. 3 shows an XRD chart of the obtained sample. As shown in FIG. 3, even if H₂ partial pressure was raised, no LiH production was observed under a state where the atmosphere was sealed.

### [Method for Evaluating Lithium Hydride Purity]

### (Preparation and Evaluation of Standard Sample)

LiNH₂ and LiH (produced by Sigma Aldrich Co., Ltd., Purity: 95%) were weighed to 966 mg and 335 mg, respectively, so that they had an equal mole to each other. These and titanium trichloride (TiCl₃) (produced by Sigma Aldrich Co., Ltd.) of 65 mg were put into the mill container mounted on the planetary ball mill apparatus, model P-5, and, after the mill container was evacuated, Ar gas was introduced so that an inner pressure thereof was 0.9 MPa before performing milling treatment for 2 hours.

The sample subjected to the milling treatment was taken out inside a glove box in an atmosphere of Ar gas (purity: 99.995%) to minimize adverse effects of sample oxidation and moisture adsorption and moved into a reaction container for hydrogen release experiment in the atmosphere of Ar gas and the reaction container was then evacuated.

Subsequently, the reaction container was heated from a room temperature to 250° C. at a temperature rising rate of 10° C./min, using an electric furnace and retained for 120 minutes at 250° C. During the temperature elevation, the gas discharged from the reaction container was cooled to 20° C., the gas pressure was measured and was taken into a gas cylinder as needed. During the retention of the reaction container at 250° C., while a gas pressure in the reaction container was adjusted using a buffer container so that the pressure of the released gas was 20 kPa or less, released gas was cooled to 20° C. the gas pressure was measured and the gas was taken into the gas cylinder as needed.

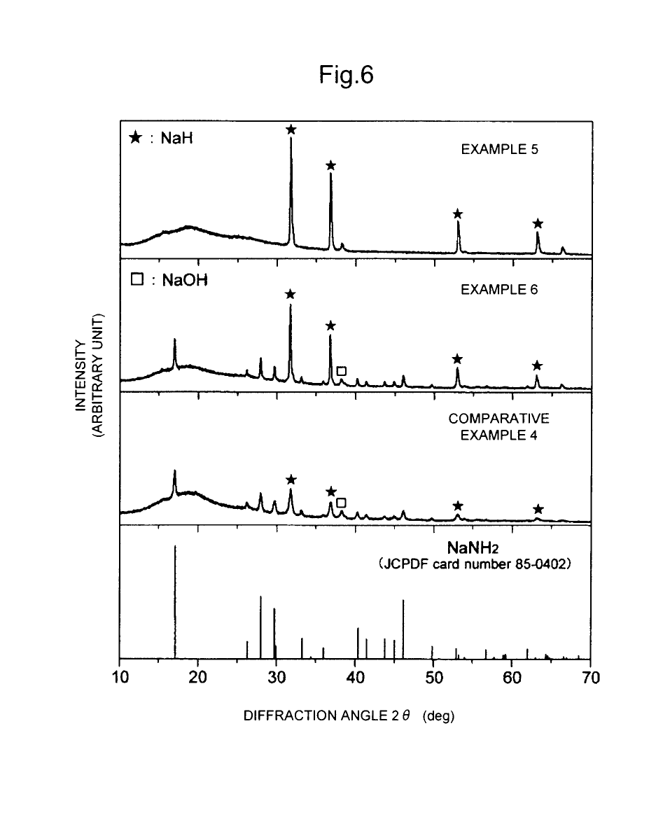

The released gas taken in this way was analyzed using a gas chromatograph (manufactured by Shimadzu Corporation, Model: GC9A, TCD detector, Column: Molecular sieve 5A) and hydrogen release amount was measured. FIG. 4 shows the measurement result.

Hydrogen production with LiNH₂ and LiH follows a reaction equation of “LiNH₂+LiH→Li₂NH+H₂”. FIG. 4 shows that the maximum hydrogen release amount is 4.73 mass %, when the reaction equation above has been completed. Because the purity of LiH used herein is 95%, 966 mg of LiNH₂ and a sample of 335 mg having an unknown LiH content (x %) are weighed. A sample obtained by mixing the weighed sample with TiCl₃ of 65 mg is heat-treated in the same way and the maximum hydrogen release amount (y mass %) is measured. Hence, LiH purity (x %) in the sample having the unknown LiH content can be determined by an equation of x=(y/4.73)×95.

### [Sample Preparation]

LiNH₂ was weighed to 1.3 g, which was put into the mill container. Next, the inside of the mill container was kept in an Ar gas atmosphere of 0.9 MPa and milling treatment was performed for 2 hours using the planetary ball mill apparatus (model: P-5). Subsequently, the obtained crushed particles of 500 mg was moved into the reaction container made of SUS and the container was heated at a predetermined temperature of 175 to 300° C. for 12 hours in gas flows conditioned to H₂ partial pressures of 0.05 MPa, 0.1 MPa and 0.5 MPa, respectively. In addition, the same test was conducted using a Li₂HN in place of LiNH₂.

### [Purity Evaluation of Prepared Sample]

To check a purity of LiH of a prepared sample, the samples, LiNH₂ and TiCl₃ were weighed to 335 mg, 966 mg and 65 mg, respectively, and put into a mill container. Next, the inside thereof was conditioned to an Ar gas atmosphere of 0.9 MPa and milling treatment was performed for 2 hours using the planetary ball mill apparatus (model: P-5).

Next, a sample of 500 mg was moved into a reaction container made of SUS from the mixed crushed particles and, after the reaction container was heated at 250° C. for 120 minutes, hydrogen release amount generated after the heating was quantified with a gas chromatograph.

Weighing LiNH₂, Li₂NH, TiCl₃ and products, putting them into a ball mill container, moving them into a reaction container, and the like were performed in a high purity Ar gas glove box.

Table 1 shows a test result using LiNH₂ as raw material and Table 2 shows a test result using Li₂NH as a raw material. LiH purity (x %) in each sample was obtained by an equation of x=(y/4.73)×95, where y is hydrogen release amount (mass %) of each sample, based on the evaluation result of the standard sample described above.

Table 1 verifies that when LiNH₂ was used as a raw material, by performing the reaction at the H₂ partial pressure in a gas flow of reaction atmosphere of 0.1 MPa and at a temperature of not less than 200° C., a product having LiH purity of not less than 50% as well as high conversion rate was obtained.

Table 2 verifies that when lithium imide was used as a raw material, by performing the reaction at a H₂ partial pressure in a gas flow of reaction atmosphere of 0.1 MPa and at a temperature of not less than 200° C., a product having LiH purity of not less than 50% as well as high conversion rate was obtained, in the same way as in the case of LiNH₂.

### [Na System]

### [Synthesis of NaNH₂]

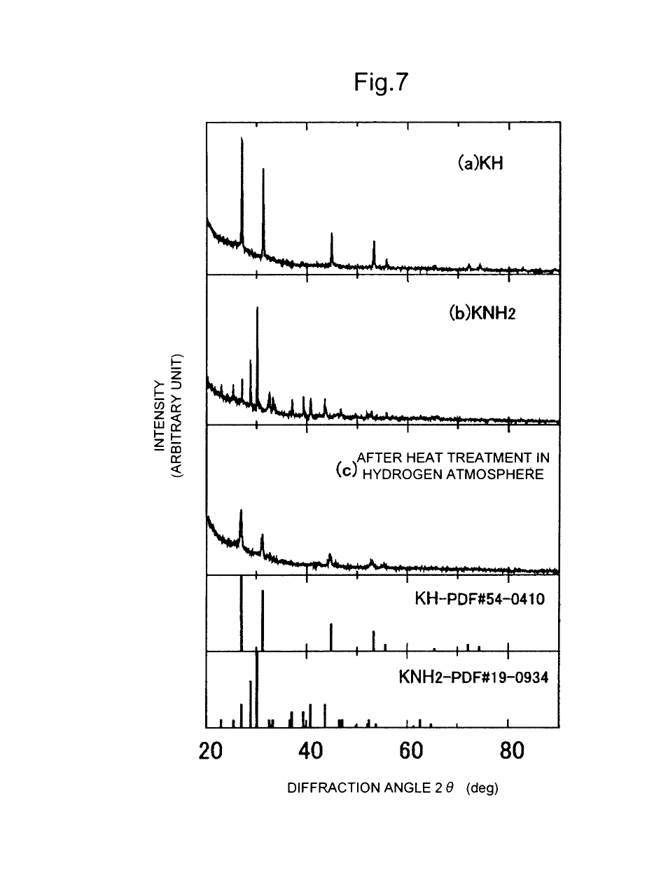

Synthesis of NaNH₂ having a high purity used for tests of Examples 5 and 6 and Comparative Example 4 described below were performed. NaH (produced by Sigma Aldrich Co., Ltd., Purity: 95%) was weighed to 300 mg, put with high-chrome steel balls (diameter: 7 mmφ) into a mill container (inner capacity: 30 cm³) made of the same material as that of the high-chrome steel balls. The inside of the mill container was maintained in a NH₃ gas atmosphere (inner pressure: 0.5 MPa) and reacted at a room temperature for two hours, using a vibrating milling apparatus (manufactured by Seiwa Giken Co., Ltd., model: RM-10). FIG. 5 shows XRD charts of the samples obtained in this way. FIG. 5 shows a diffraction pattern as well, described in JCPDF Card No. 85-0402. FIG. 5 verifies that single-phase NaNH₂ powder was substantially obtained. After the purity of the NaNH₂ powder as a product was measured from the weight increase amount of a sample in the mill container, it was verified that the purity was almost 100%.

### Sample Preparation for Examples 5 and 6 and Comparative Example 4 and Structural Analysis with X-ray Diffraction Apparatus

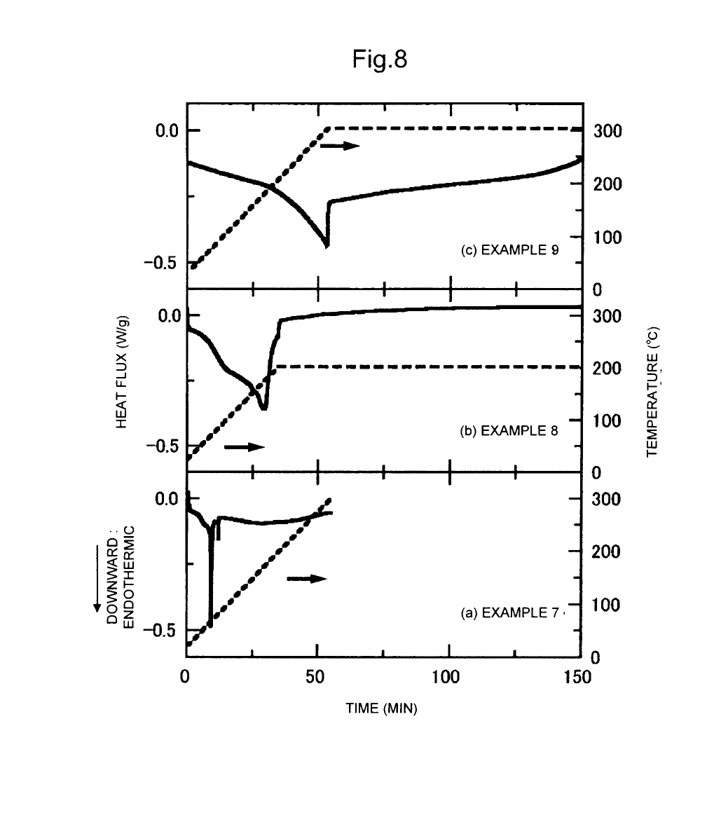

5 mg of NaNH₂ obtained as described above was taken, from which the following three heat-treated products were prepared for phase identification with XRD, respectively: a heat-treated product (Example 5) maintained at 200° C. for four hours in a gas flow having a H₂ partial pressure of 0.5 MPa, a heat-treated product (Example 6) maintained at 100° C. for four hours in a gas flow having a H₂ partial pressure of 0.5 MPa, and a heat-treated product (Comparative Example 4) maintained at 200° C. for four hours in a gas flow having a H₂ partial pressure of 0.05 MPa. FIG. 6 shows XRD charts thereof.

As shown in FIG. 6, production of NaH was observed in all of Examples 5 and 6 and Comparative Example 4. However, it was observed that NaNH₂ remained in the Comparative Example 4 where the H₂ partial pressure was low, which indicates that the purity of NaH was low. NaH production was observed even at a low temperature of 100° C. in a hydrogen flow of 0.5 MPa as in Example 6, and it was verified that metal hydride can be produced even at a lower temperature in the case of NaNH₂ than in the case of LiNH₂ (in the case of Equation (1A)). In Example 5, the purity of NaH was substantially 100%. It was thus verified that the higher purity was obtained at a lower temperature than in the case of LiNH₂ (in the case of Equation (1A)). Measurement of the purity of NaH is determined by measuring the weight of a product.

### [K System]

### [Synthesis of KNH₂]

Synthesis of KNH₂ having high purity used for a test of Example 7 described below was performed. First, K (produced by Sigma Aldrich Co., Ltd., purity 99.95%) was weighed to 100 mg and was maintained at 600° C. in an H₂ atmosphere of 1 MPa for 24 hours. FIG. 7(a) shows an XRD chart of an obtained sample. FIG. 7 shows a diffraction pattern as well, described in JCPDF Card No. 54-0410. FIG. 7(a) verifies that KH has been synthesized. Next, the obtained KH was weighed to 50 mg and reacted at a room temperature for 24 hours in an NH₃ gas atmosphere of 0.5 MPa. FIG. 7(b) shows an XRD chart of an obtained sample. FIG. 7 shows a diffraction pattern as well, described in JCPDF Card No. 19-0934. FIG. 7(b) verifies that single-phase KNH₂ powder has been substantially obtained. The purity of KNH₂ powder as the product had been measured from the weight increase amount of the sample after reaction with NH₃, it was verified that the purity was almost 100%.

### Sample Preparation for Example 7 and Structural Analysis with X-Ray Diffraction Apparatus

4.33 mg of KNH₂ obtained in the above way was taken and put into a reaction container (inner capacity: 300 ml) made of SUS. The container was set on a differential scanning calorimeter (DSC) (manufactured by TA Instruments Inc., model: Q10 PDSC) and was heated to 300° C. at a temperature rising rate of 5° C./min in a gas flow (50 ml/min) having a H₂ partial pressure of 0.5 MPa. The obtained sample was phase-identified with XRD. FIG. 7(c) shows an XRD chart thereof. FIG. 7 shows a diffraction pattern as well, described in JCPDF Card No. 54-0410. As shown in FIG. 7(c), KH production was observed in Example 7. A weight change in a sample before and after heat treatment with DSC was measured and, the result of the calculation of a reaction rate based on the reaction equation (3A) was 76%. (Weight before measurement: 4.33 mg [symbol] weight after heat treatment: 3.43 mg)

### [Evaluation of Hydrogen Storage Temperature by DSC Measurement]

FIG. 8(a) shows a DSC curve (Example 7) of KNH₂ powder during heat treatment by DSC described above. As shown in FIG. 8(a), heat absorption by hydrogen storage was observed and an endothermic peak temperature was 65° C.

For the LiNH₂ powder which had been used to prepare a sample of Example 1 and the NaNH₂ powder which had been synthesized to prepare a sample of Example 5, DSC measurement and hydrogen storage temperature evaluation were performed, respectively. DSC measurement conditions were as follows: In a gas flow (50 ml/min) having a H₂ partial pressure of 0.5 MPa and at a temperature rising rate of 5° C./min, NaNH₂ powder was maintained at 200° C. after heating to 200° C. (Example 8), while LiNH₂ powder was maintained at 300° C. after heating to 300° C. (Example 9). FIG. 8 shows the respective DSC curves.

As shown in FIG. 8, heat absorption by hydrogen storage was observed in either case. Comparison of peak temperatures of the heat absorption has verified that the peak temperatures were 300° C. or more and 195° C. in Example 9 (LiNH₂ powder) and in Example 8 (NaNH₂ powder), respectively, and KNH₂ powder had the lowest peak temperature in a hydrogen storage reaction. Accordingly, as shown in Example 7, KH production was observed at 65° C. significantly below 100° C. in a hydrogen flow of 0.5 MPa and it has been verified that KNH₂ can produce metal hydride even at a lower temperature than in the case of LiNH₂ (in the case of Equation (1A)) or NaNH₂ (in the case of Equation (2A)).

TABLE 1

| HEAT- | HYDROGEN | HYDROGEN | |
|---|---|---|---|
| TREATMENT | PARTIAL | RELEASE | |
| TEMPERATURE | PRESSURE | AMOUNT | LiH PURITY |
| (° C.) | (MPa) | (MASS %) | (%) |
| 175 | 0.5 | 1.27 | 25.6 |
| 200 | 0.05 | 1.43 | 28.7 |
| | 0.1 | 2.56 | 51.5 |
| | 0.5 | 3.36 | 67.6 |
| 250 | 0.05 | 2.12 | 42.5 |
| | 0.1 | 3.42 | 68.7 |
| | 0.5 | 4.01 | 80.6 |
| 300 | 0.05 | 1.77 | 35.6 |
| | 0.1 | 3.74 | 75.3 |
| | 0.5 | 4.61 | 92.6 |

TABLE 2

| HEAT- | HYDROGEN | HYDROGEN | |
|---|---|---|---|
| TREATMENT | PARTIAL | RELEASE | |
| TEMPERATURE | PRESSURE | AMOUNT | LiH PURITY |
| (° C.) | (MPa) | (MASS %) | (%) |
| 175 | 0.5 | 1.76 | 35.3 |
| 200 | 0.05 | 1.68 | 33.7 |
| | 0.1 | 2.77 | 55.6 |
| | 0.5 | 3.76 | 75.7 |
| 250 | 0.05 | 2.03 | 40.8 |
| | 0.1 | 3.75 | 75.4 |
| | 0.5 | 4.16 | 83.6 |
| 300 | 0.05 | 2.27 | 45.6 |
| | 0.1 | 4.01 | 80.7 |
| | 0.5 | 4.74 | 95.2 |

1. A method for producing a metal hydride comprising: reacting hydrogen with either one or both of a metal amide and a metal imide to produce a metal hydride in a gas flow containing the hydrogen having a hydrogen partial pressure of 0.1 MPa or greater.

2. The method for producing a metal hydride according to claim 1, wherein a metal constituting the metal amide and the metal imide is lithium, sodium or potassium.
